(19) United States
(12) Patent Application Publication
(10) Pub. No.: US 2011/0086632 A1
(43) Pub. Date: Apr. 14, 2011

(54) OBJECT RANGE DETECTOR AND LOCK DOWN DEVICE

(76) Inventors: David M. Tumey, Germantown, MD (US); R. William Graham, Dayton, OH (US); Jane C. Graham, Oklahoma City, OK (US)

(21) Appl. No.: 12/578,184

(22) Filed: Oct. 13, 2009

(51) Int. Cl. H04M 11/00

(52) U.S. Cl. 455/421

(57) ABSTRACT

A range detector system includes an safety system, a first electronic object, and a second electronic object, wherein the first and second electronic objects are wirelessly communicably connected in a manner equipped such that when the first object and the second object are moved from a first predetermined distance range from each other to a second predetermined distance range from each other, the safety system is operably deployed on at least one the first and the second objects is activated.

### BACKGROUND OF THE INVENTION

1. Field of the Invention

The invention relates to object location and control thereof. More particularly, but not by way of limitation, the invention relates to an object range detector and lock down device for mobile phone, PDA, PC's and the like.

2. Background and Prior Art

PDA's, laptop computers, and cellular telephones, for example, are electronic devices which typically are expensive and maintain personal information. It is not uncommon for these items to be misplaced, inadvertently left, lost or stolen.

Prior hereto, there have been many devices which exist to attempt to find the location of the item which is sought. The instant invention provides an improvement on such devices as disclosed hereafter.

### SUMMARY OF THE INVENTION

It is an object to provide a range detector for an object.

It is another object to provide lock down device for an object.

It is a further object of the invention to provide an object locating system.

It is a still further object of the invention to provide for a web activated system for enabling and disabling electronic objects.

It is yet a further object of the invention to provide a device for detecting object range, location and lockdown which may be inexpensively manufactured.

It is a further object to provide a portable backup device for a phone.

The invention is directed to a range detector system which includes a first electronic object and a second electronic object, wherein the first and second objects are wirelessly communicably connected in a manner equipped such that when the first and second objects are moved from a first predetermined distance range from each other to a second predetermined distance range from each other, an safety system which is operably deployed on one or both objects is activated. Further, one or more objects can be equipped with software to automatically lock down one or more other features of the object once outside the first predetermined distance range. For example, in the case of one object being an smart phone, and the other object being a key fob, once the two are out of the first range which can be operably defined in the software of the instant invention such as 15 feet, the smart phone locks down and requires its user password to activate. In addition, an object of the instant invention can be equipped with a GPS locating system and can report its location to the owner via a web site specifically designed to perform such service. Likewise, an object of the instant invention may include a camera and could be configured to transmit photographic images of the thief, for example.

A further object is to provide a safety system which is equipped to provide change of intensity in response to distance from paired objects.

One or both objects can be equipped with remote locator for the other object. This can be done through activation of each object using the Internet and a registration of the objects prior to use. For example, in the case of the smart phone, once the objects are paired with Bluetooth™ for example, a software application can be downloaded from the smart phone enabling various programmable features for purposes of operating such as setting distance ranges and locating features of each through GPS technology.

The safety system can include an audible, such a beeper, a visual, such as a light or LED or a vibrator. Each of the objects can include a software code which corresponds to a code in the other object. The activation of the safety system occurs after the objects are displaced from each other outside the first distance range and are reactivated once inside the range. It is further contemplated that one or both objects can be equipped with software/hardware which renders apparent the use of the other object within or outside of the first distance range. This could be for example a wireless headset or phone which indicates the other's use in one or more manners, such as audible sound or visual message. Another aspect of the invention is to provide for activating the safety system of one or more objects which can preferably include an intensity change as a function of distance between the paired objects.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a diagram illustrating the invention in a first mode;

FIG. 2 is a diagram illustrating the invention in a second mode; and

FIG. 3 is a block diagram illustrating operational steps of employing the invention.

### DETAILED DESCRIPTION OF THE PREFERRED EMBODIMENTS

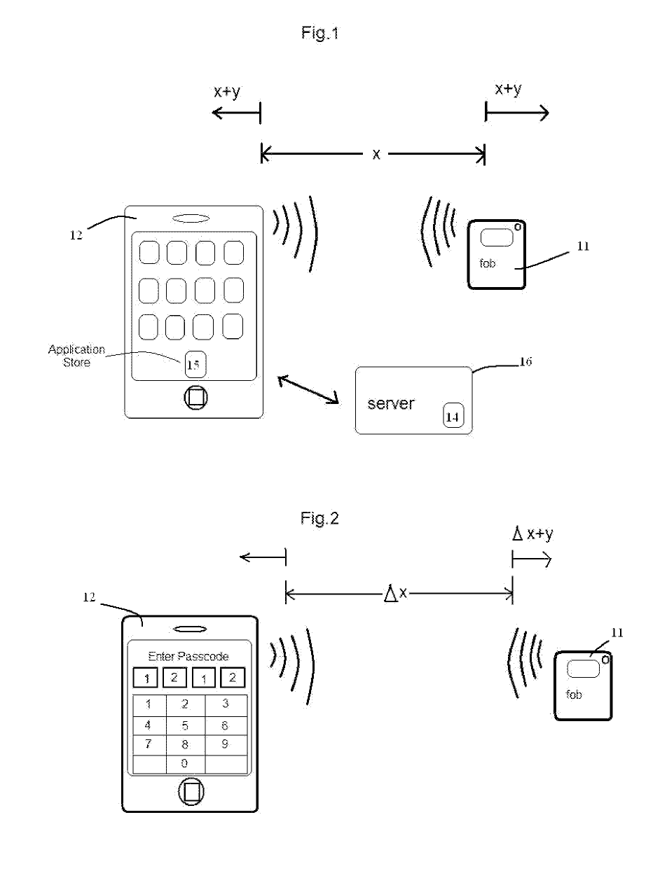

Referring now to the invention, FIG. 1 illustrates a block diagram of an exemplary embodiment of the instant invention which is generally referred to by the numeral 10. For purposes of illustration, but not by way of limitation, exemplary embodiment 10 includes a key fob 11 and a cellular phone 12, but could be a computer, PDA or other device. Phone 12 can be for example, a Blackberry™, (or iphone™, for example) which is an Internet-connected, multimedia smartphone designed having minimal hardware interface which may or may not have a physical keyboard. In the case of a multi-touch screen, there it renders a virtual keyboard when necessary and includes operating software, such as Android™, Blackberry™ or itouch/phone OS operating system. The operating software here referred to as 15 in FIG. 1 can permit the downloading of object range detector and lock down software 14 which is described hereinafter from a server 16 via the Internet. The phone 12 is also conventionally equipped with hardware and software to enable, a camera and text messaging, visual voicemail, a portable media player (equivalent to a video, mp3), and an Internet client (with email, web browsing, and Wi-Fi connectivity), quad-band GSM with EDGE and added UMTS with HSDPA.

The key fob device 11 like phone 12 can be equipped with circuitry for detecting and alerting of distance range therebetween. In this regard, the phone 12 and device 11 preferably can be equipped with Bluetooth™ technology, a 802.151a standard, creating a single digital wireless protocol, capable of connecting phone 12 with device 11 and enabling synchronization. This form of communication enables short-range wireless communication. Other forms of communication can be employed, such as rfid, in the case of communicating with a chip disposed on one or both devices 11, 12. In the case of a phone 12 not providing multiple applications to operate, the rfid device can be operably disposed on the phone 12 and the fob 11 can provide alarm operations described herein.

Preferably, Bluetooth™ RF transceivers 18 and 20 operably reside on phone 12 and device 11, respectively. There are 79 Bluetooth™ channels spaced 1 MHz apart. A spread spectrum technology is used at the transceiver physical layer. Both voice and data transmissions over short distances are possible, creating wireless Personal Area Networks (PANs). Device 11 and phone 12 can both preferably include a Bluetooth™ adapter and processing element 22 and 24, respectively, which includes instructions embedded therein to enable communication which each other.

When device 11 and phone 12 come within each other's radio range, each include link manager protocol (LMP) software to discover each other. Link management protocol engages itself in peer-to-peer message exchange. LMP performs link setup and negotiation of packet size. Segmentation and reassembly of packets is done, if needed.

Once a connection is established via a piconet connection, for example, one of the phone 12 or device 11 acts as the master and others act as slave in order to synchronize and is capable engaging services over the piconet. A Bluetooth Global ID is exchanged between the device 11 and phone 12. Their profiles are matched and a connection is setup.

Bluetooth uses frequency hopping in timeslots, which means that the Bluetooth signals avoid interference with other signals by hopping to a new frequency after transmission or reception of every packet. One packet can cover up to five time slots. Bluetooth can support an asynchronous data channel, or up to 3 simultaneous synchronous voice channels, or a channel, which concurrently supports asynchronous data and synchronous voice.

In the instant invention, it is contemplated that either device 11 or phone 12 can serve as a master or slave for purposes of using Bluetooth technology wherein the slave has to wait until the master allows them to talk. The instant invention contemplates File Transfer which permits talking of an object transfer or transfer of files between devices; Internet Bridge: a cordless modem acts as a modem to a PC and provides dialup networking and faxing; LAN Access:—Multiple data terminals use a LAN access point (LAP) as a wireless connection to an Ethernet LAN; Synchronization:—Synchronization model provides a device-to-device synchronization of data.

Here, the device 11 can be part of or a fob on a key chain or a headset which is wirelessly connected to the phone 12. The master unit uses its clock and hopping frequency to synchronize other devices in the piconet. The master device numbers the communication channels. The slave units act in co-ordination with the master.

Thus, each of the phone 12 and device 11 include Bluetooth™ RF transceivers 18 and 20, for receiving an encoded RF signal and for decoding the encoded RF signal under the object range detector and lock down software 14 (which is here shown on phone 12 or fob 11, but it is contemplated that it can be employed on other processing units). As long as the RF signal remains in a predetermined distance range the object range detector and lock down software 14 enables function of the device 11 and/or phone 12. A safety system 36 (here shown on the device 11 but could also be employed on the phone 11) can include an audible beeper, vibrator or light is enabled to draw attention thereto when the device 11 and phone 12 are outside the predetermined range, for example 15 feet of one another. The safety system 36 will continue to sound until disabled by a reset button 38 or security code. Once outside the predetermined range distance, ΔX+Y, the object range detector and lock down software 14 triggers an alarm or a lock down of one or both device 11 and phone 12. The phone 12 or device 11 can be activated by bringing the same within the range distance ΔX as in FIG. 1 or inputting a predetermined pass code as illustrated in FIG. 2.

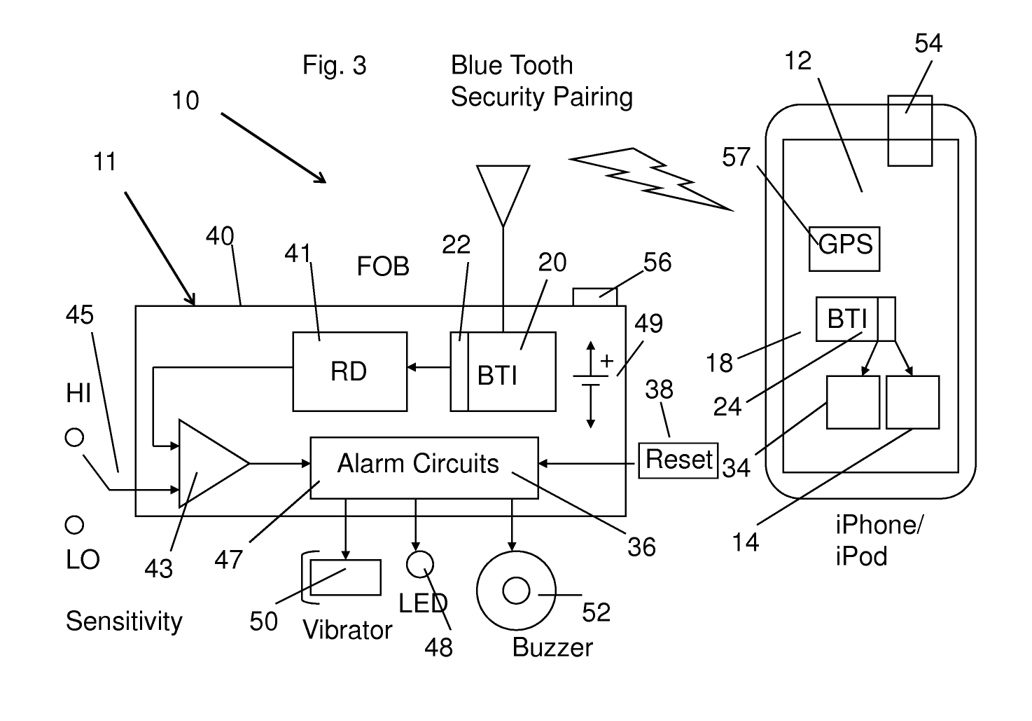

FIG. 3 is a block diagram, illustrating the invention. The device 11 can be brought within RF (e.g., Bluetooth) range of phone 12 to initiating pairing between the same. Either prior to or after pairing, object range detector and lock down software 14 can be downloaded from server 16 onto phone 12, for example, using the application loader of the iPhone 12. Once loaded, the Bluetooth™ RF transceivers 18 and 20, for receiving an encoded RF signal and decoding the encoded RF signals under the scrutiny of a software code program 34. When an RF signal modulated by a code matching the code program 34 is received, a signal is provided (such as beep) indicating the pairing complete. If the phone 12 and device 11 exceed predetermined range distance ΔX, then safety system 36 is activated until disabled by a reset button 38 or security code. Additionally, the software code program 34 is equipped to trigger an alarm or a lock down of one or both device 11 and phone 12 until such security code is entered or the two are brought in range distance ΔX again. In the case of software residing on phone 12, a user can set preferential ranges to determine the specific functions, such as alarm or lock down. Referring now particularly to FIG. 3, the distance between devices can be ascertained by range detector 41. Radio frequency energy decreases in proportion (1/r²) to distance between the sending and receiving objects. Thus, the distance between the devices can be generally ascertained with an acceptable margin of error by measuring RF signal strength. This information is then transmitted to processing element 43 which can be one of many microprocessors such as a Programmable System on Chip (PSoC) well known to anyone of ordinary skill in the art and available under the trademark Cypress Semiconductor. A predetermined threshold can be selected via a hardware switch 45, for example or by software resident in phone 12. Alarm circuits 47 are provided to energize one or more warning transducers including an LED or light, vibrator or buzzer. Manual reset button 38 can be provided to permit silencing and resetting of device 11 once the alert has been acknowledged by the user. Device 11 can be powered by an internal rechargeable battery 49 which can be one of a NiMH, LiIon or NiCd chemistry and is well known to anyone of ordinary skill in the art. Battery 49 can be recharged by connecting it to a “wall wart” power supply that converts 120 VAC domestic voltages to levels suitable for recharging batteries, for example.

In another aspect of the invention, each of the phone 12 and device 11 can be equipped to send/receive through the Bluetooth™ RF transceivers 18 and 20 a signal using software code program 34 which activates/deactivates safety system 36 for purposes of aiding in locating the other unit. In this regard the object range detector and lock down software 14 can be used to communicate with a signal in a second distance range using RF or other communication means, WAN, WAP, LAN, etc.

An advantage of the instant invention over the art resides notably in the prevention of loss or theft of an object of significant value. In addition to aiding in locating a lost object, the object is less likely to becomes lost or stolen if its proximity range is alerted to the owner.

The device 11 can include a housing 40, controller 43, power source 49, transceiver 20, switch 45, light emitting diode (“LED”) 48, vibrator 50 and beeper 52. A SIM 54—Subscriber Identity Module, a “Smart Card” chip that establishes a unique identifier for the device 12 can be employed. SIM 54 identifies the device 11 to a phone 12 and allows it to communicate therewith. Power source 49, such as a battery is electrically connected to charger port 56 to allow for recharging. Power source 49 is electrically connected to controller 43 and to all other electronic components in device 11 that require power to function.

Controller 43 can be a single chip microcomputer such as a Cypress Semiconductor CY8C27243 microcontroller which is electrically connected to power source 49, switch 45, transceiver 20, LED 48, vibrator 50 and beeper 52 and SIM 54. These electrical connections allow controller 43 to operate each of the other components to perform the functions described herein. A GPS receiver 57 can optionally be employed to enable position location through object range detector and lock down software 14. The object range detector and lock down software 14 can also provide for activation of the safety system 36 which can preferably increase intensity in its alert function, such as increase volume, as a function of distance between the phone 12 and device 11 to aid as a locating device for the other object.

In a preferred embodiment of the invention, object range detector and lock down software 14 can preferably be equipped to exchange and cache information data between the phone 12 and FOB 11. An additional feature of the object range detector and lock down software 14 is to provide a backup data feature wherein data can be automatically cached and stored on the paired device 11 and phone 12, wherein such data as address list, photos, other can to be retrieved if lost. In this way a back up of data is enabled. Thus, sensitive information such as address list, photos, other data can be retrieved if desired and upon having proper authorization. In this regard, object range detector and lock down software 14 can preferably be equipped to prevent tampering with data by providing certain password protection features.

The object range detector and lock down software 14 can be equipped for pairing between the phone 12 and FOB 11. As indicated, the object range detector and lock down software 14 is equipped for enabling range selection in order to trigger one of the alert features, wherein the range can be set to alert at close, near, or far distance.

Further, the object range detector and lock down software 14 can preferably be equipped to enable/disable the other component by manual operation or by way of preset range of separation. Further, object range detector and lock down software 14 on either the phone 12 or device 11 can be equipped to mute an alert or stop alarming once the other is located.

Further, the object range detector and lock down software 14 can be equipped to transfer information/data from FOB 11 to Phone 12, such as battery life data, out of range data, alarm trigger data. The object range detector and lock down software 14 operation can be equipped such that upon pairing, FOB 11 and/or phone 12 beeps/flashes indicating successful connection. When disabled, FOB 11 and/or phone 12 beeps/flashes indicating protection lost. When phone 12 and/or FOG 11 is powered off, e.g. pairing broken, FOB 11 and/or phone 12 beeps/flashes continuously.

Additionally, object range detector and lock down software 14 can be equipped to periodically send operational information data, such as battery status between the phone 12 and FOB 11 for display/warning low power. FOB 11 or phone 12 can, for example, beeps or flashes one short shot every 15 seconds when battery is critical.

The object range detector and lock down software 14 can select and send range selection information between the FOB 11 and phone 12 where it is stored until changed. For example, when FOB 11 and phone 12 are outside selected range, FOB 11 and Phone 12 alarm (beep/flash).

Each time one of the phone 12 and FOB 11 is turned on or comes into pairing range, object range detector and lock down software 14 can be equipped to determine if any changes have been made to the other, such as software applications, information, data, etc. This would prevent anyone from tampering alert as well as prevent anyone from tampering with the other paired device.

It is envisioned that the object range detector and lock down software 14 can be downloaded onto or communicate with a computer, for example, to allow for downloading of information, such as providing button on a software screen which will allow important data, address list, photos, or other data to be backed up to and retrieved from the FOB 11 or phone 12.

It is further envisioned, that the object range detector and lock down software 14 is equipped to send GPS information to a central location enabling users to log onto a website and see location of phone 12 or FOB 11. If the phone 12 or FOB 11 is turned off by a thief after the alarm trigger (such as by moving out of range), the phone 12 or FOB 11 will keep turning on and alarming and sending a signal which can be viewed by object range detector and lock down software 14. Still another feature is a locator button which is operably associated with object range detector and lock down software 14 to cause the FOB 11 or phone 12 to chirp or the like enabling location of the paired device. Another feature of the object range detector and lock down software 14 can be to power down the other device once passing a predetermined range of the other.

There are numerous advantages of the instant invention. Notably, the invention significantly aids in the prevention of loss and theft of not only the objects, but sensitive information retained therein. The device of the instant invention is a relatively inexpensive add-on to relatively expensive objects, such as PDAs, cell phones and computers (e.g., laptop).

When the objects enter a range of one another, they start communicating on their own to enable operation, while providing an alternative override by the actual user through entering a pass code thereby permitting use in the event of loss of a component. The process of setup can be automated by downloading object range detector and lock down software 14 first on one object prior to pairing operation wherein the object range detector and lock down software 14 automatically initiates pairing and installation. By employing Bluetooth™, this uses low power signals, thus requiring less energy. It is contemplated that other communication signals may be a radio frequency signal, “Wi-Fi” signals designed to communicate with local data networks, “Wi-Max” or “Wi-MAN” signals designed to communicate wireless broadband networks, 3G or 4G signals for future wireless communications, standard cellular telephone signals, or a specialized signal expressly for this purpose. Preferably, the activating signal (if it is a direct RF signal) is any signal but the last mentioned. This allows a standard cellular telephone device to serve as the activation unit. Other signals may be optical signal or an acoustic signal, RF to carry out one or more functions is contemplated.

While the present invention has been set forth above in a preferred embodiment, it is contemplated that other modifications, improvements and derivations will be readily apparent to those skilled in the art. Thus, the hardware and software described herein provide protective functions to the paired devices. A FOB 11 can include a device for carrying on one's key chain or to be worn on a necklace or around one's wrist, for example. Accordingly, the appended claims hereto should be accorded the full scope of protection of any such modifications, improvements and derivations.

What is claimed is:

1. A range detector system, which includes:
a safety system;
a first hand held electronic object; and
a second hand portable electronic object, wherein said first and second electronic objects are wirelessly communicably connected in a manner equipped such that when said first object and said second object are moved from a first predetermined distance range from each other to a second predetermined distance range from each other, said safety system operably deployed on at least one said first and said second objects activates a protective function on at least one of said first and said second objects.

2. The range detector system of claim 1, which includes software operably associated with one at least one of said electronic objects to automatically lock down at least one feature of at least one of said electronic objects when said objects are outside the first predetermined distance range.

3. The range detector system of claim 1, wherein one of said objects is one of a phone, PDA and computer.

4. The range detector system of claim 1, wherein one of said objects is a FOB.

5. The range detector system of claim 1, wherein said first object is a one of a wireless phone, PDA and computer equipped with pairing hardware and software and said second object is a wireless FOB equipped with pairing hardware and software to enable pairing therebetween.

6. The range detector system of claim 2, wherein said protective function is performed by said software which requires a password to enable operation of one of said objects when in said second predetermined distance range.

7. The range detector system of claim 1, wherein said software is equipped with a GPS locating system by transmitting a signal of its location when in said second predetermined distance range.

8. The range detector system of claim 7, which further includes a computer based device operably connected to an Internet for receiving said signal and enabling an authorized party to access said signal in a manner to determine location of said object transmitting said signal.

9. The range detector system of claim 2, which further includes a camera operably associated on at least one of said electronic objects and said software is equipped to capture and transmit photographic images during attempted use when in said second predetermined distance range.

10. The range detector system of claim 1, wherein said safety system is equipped to provide change of intensity in response to a change in distance between said first object and said second object.

11. The range detector system of claim 1, which includes a manually activated locator hardware and software on at least one of said first electronic object and said second object for enabling locating said other electronic object.

12. The range detector system of claim 1, wherein said objects are wireless connected and paired.

13. The range detector system of claim 1, wherein said safety system includes one of an audible, a visual, and a vibrating alert device.

14. The range detector system of claim 2, wherein said software is equipped to exchange and cache information data between said first and said second objects.

15. The range detector system of claim 2, wherein said software is equipped for setting said ranges in order to trigger said feature.

16. The range detector system of claim 2, wherein said software is equipped to enable/disable one of said first and said second electronic objects by manual operation using said other one of said electronic objects.

17. The range detector system of claim 2, wherein said software is equipped to enable/disable at least one of said first and said second electronic objects automatically by way of preset range of separation.

18. The range detector system of claim 2, wherein said software one at least one of said first and second electronic objects is equipped to deactivate said safety system.

19. The range detector system of claim 2, wherein said software is equipped to transfer operational information/data between said first and said second devices when in said first predetermined distance range.

20. The range detector system of claim 2, wherein software is equipped such that upon establishing a communication between said first and said second electronic object, at least one of said electronic objects is equipped with an indicator for indicating successful connection therebetween.

21. The range detector system of claim 2, wherein software is equipped such that upon de-establishing a communication between said first and said second electronic object, at least one of said electronic objects is equipped with an indicator for indicating disconnection therebetween.

22. The range detector system of claim 2, wherein software is equipped such that when said first object and said second object reestablish connection a signal is generated indicating whether there has been a change in cache of one of said objects.

23. The range detector system of claim 2, wherein said software is equipped to power down the at least one of said objects when moving into said second predetermined distance range.

24. The range detector system of claim 1, wherein said safety system is equipped for setting said ranges in order to trigger said protective function.
